(19) United States
(12) Patent Application Publication
(10) Pub. No.: US 2023/0212888 A1
(43) Pub. Date: Jul. 6, 2023

(54) BOLT LOCK DEVICE

(71) Applicants: Jörg Semmler, Kösching (DE); Philipp Mann, Kösching (DE)

(72) Inventors: Jörg Semmler, Kösching (DE); Philipp Mann, Kösching (DE)

(21) Appl. No.: 18/001,186

(22) PCT Filed: Jun. 10, 2021
(86) PCT No.: PCT/EP2021/065609

§ 371 Date: Dec. 8, 2022

(30) Foreign Application Priority Data
Jun. 10, 2020 (DE) 20 2020 103 350.6
Jun. 10, 2020 (EP) 20179295.9

(51) Int. Cl. E05B 67/36; E05B 15/08; E05B 83/02

(52) U.S. Cl. CPC E05B 67/36; E05B 15/08; E05B 83/02; E05B 35/008

(57) ABSTRACT

The invention relates to a bolt lock device for securely locking doors of fixed-walled storage or transport containers, in particular large-capacity storage or transport containers made of metal, such as in particular freight containers or commercial vehicle trailers, and the container having a bolt lock device of this kind.

The invention relates to a bolt lock device for securely locking doors of fixed-walled storage or transport containers, in particular large-capacity storage or transport containers made of metal, such as in particular freight containers or commercial vehicle trailers, and the container having a bolt lock device of this kind.

### BACKGROUND OF THE INVENTION

Conventional storage or transport containers as they are currently employed worldwide for the storage or transport of goods by sea, by land or by air, have a container locking mechanism to guarantee transport security, said container locking mechanism also being able to be lockable. Locking mechanisms of this kind and their locks, however, are exclusively installed on the outside of the respective container doors and are thus easily accessible. This also means, however, that locking mechanisms of this kind only offer insufficient protection from unauthorised or violent opening of the container.

GB 2 327 967 relates to a locking device in particular for doors and gates having a slidable internal bolt. The bolt can be slid into and locked in different positions. The corresponding lock is accessible from outside, however.

DE 10 2008 032 525 and FR 3 010 709 respectively relate to locking devices for containers having internal bolts. Both devices described here, however, are based on guiding a one-piece locking pin through a corresponding internal guide fixed to the container doors and screwing it there. An opening is made more difficult only by a special profile being formed on the head of the pin, said special profile not being able to be operated by usual means. The pin must be entirely screwed out and removed to open the container door in both cases.

DE 35 38 203 C2 relates to a special cylinder locking device having an internal conical guide for easily introducing the key into the keyhole. A bolt lock device for container doors is not described there.

DE 10 2016 000 561 describes overseas containers having two-winged doors and a door locking mechanism that can be operated from outside installed on the inner side of only one of the two door halves. As can for example be understood from the FIGS. 2 and 3 here, a locking rod is formed on the inner side of a first door half in a slidable manner, and engages in the closed state in a bracket installed on the second door half in the immediate vicinity of the door crack between the two door halves. The embodiment depicted in FIGS. 2 and 3 additionally comprises a crank, by means of which the locking rod is screwed into the bracket in order to lock the two-winged door from the inside. It is embodied in the description that the operating means for the locking rod (there described as a “removable control rod”) is introduced via a lateral operating opening in the wall of the overseas container, and can be placed on the locking rod in order either to slide the locking rod in the longitudinal direction (longitudinally/axially) or, in the event of embodiment as a threaded rod, to set it in rotation. The embodiment of an arresting device for the bolt, in particular a lock, on the end of the locking rod facing the lateral operating opening, and the axially slidable operation of these two elements together within a bolt guide is not described there. The device suggested there is still unsatisfactory in several aspects. On the one hand, the bolt guide there is formed as simple bar-shaped mounts on the inner side of only one door half, and offers no optimal protection for the locking rod. The lateral opening is secured for feeding the removable control rod via a padlock located on the outside of the container. This securing is insufficient, however, as it can be violently opened from outside at any time, such that the locking rod can be seen and is accessible from outside without difficulty and the container can thus be opened without authorisation. A further disadvantage can be seen in that the second door half is only insufficiently mechanically secured by the device described there, as the locking rod there only reaches to the bracket installed on the second door half in the region of the door crack.

US 2020/0024877, as shown in FIG. 1A there, depicts a locking cylinder, via which a locking pin is formed in a housing enclosing it in a slidable manner and engages in an intake in the closed state. The locking cylinder is of course screwed to the door leaf via the bolt mount. The operation can of course occur over both sides of the locking cylinder. An ability of the arresting device (locking cylinder) and locking pin to be slid together is thus also not provided in the technical instruction there. A usage for locking containers is not described.

U.S. Pat. No. 4,669,767 relates to generic internal locking devices for transport containers having a two-winged door. As can be understood from FIGS. 2 and 3, the locking pin is introduced into the container wall via a lateral opening, and is fixed to the inner side of the container doors via brackets and guides. To arrest the pin, a lock installed in a lateral opening is provided, whose pin can be moved perpendicularly to the bolt and engages in a corresponding recess in the bolt in the closed state. The lock is thus only secured to the outside via one lockable flap. In this arrangement too, no arresting device that is arranged together with the sliding bolt, able to be axially slid within a bolt guide, is described. This device too is not satisfactorily formed in several aspects: the bolt lock is not inwardly set back, and can thus be easily manipulated. The lockable lateral flap is easy to manipulate, whereby the actual padlock is easily accessible and can also be easily manipulated. The locking pin formed in one piece is connected to the inner side of the container doors via simple rings screwed to the container door. The one-piece locking pin must also be completely laterally pulled out to open the container, as it is dimensioned such that it engages in the closing plates fixed to both container wall longitudinal sides in the closed state. Even a regular opening and closing of the container is thus made unnecessarily difficult.

WO 2008/030178 relates to a generic internal bolt lock device for two-winged container doors, wherein, however, as can be understood from FIGS. 1 and 2 there, the internal bolt can be arrested via a lock formed pointing outwards on a door leaf, and can also be slidably operated within a bolt guide via an operating means formed as a rotatable knob that is also formed on the outer side of the door. In the device there too, the sliding bolt and arresting device are not formed in a manner in which a slidable operation together in the bolt guide is enabled. Both the operating means there and the lock there are also arranged outside on the container door, and thus make a violent opening of the latter easier.

There is thus a great need for transport and storage containers having improved locking mechanism technology, in particular locking mechanisms having improved protection from unauthorised or violent opening.

### SUMMARY OF THE INVENTION

The object of the present invention is thus to provide a locking mechanism device for storage or transport containers, such as for example containers and commercial vehicle trailers, that makes their unauthorised or violent opening more difficult in comparison with conventional devices or prevents it entirely.

This object is solved by a bolt lock device, doors equipped with said bolt lock device and storage or transport containers equipped with said bolt lock device, as defined in the attached claims. An effective protection from unauthorised or violent opening of the containers is provided from outside in a particularly advantageous manner by the device according to the invention. A protection is guaranteed as far as possible from unauthorised or violent opening of the container via the installation according to the invention of the bolt lock device on the door inner side, and its ability to be operated exclusively via a small-sized operating opening formed laterally on the doorframe that substantially only enables a mechanical locking and unlocking of the device according to the invention and a longitudinal sliding of the sliding bolt of the device according to the invention within a tubular bolt guide fixedly connected to the door inner side between two given bolt positions by means of a rod-shaped operating means from outside.

### DESCRIPTION OF FIGURES

FIG. 1 shows different views of a two-winged container door 100 equipped with a bolt lock device 1 according to the invention. FIG. 1a here shows an internal view of the two-winged door 100 in which the bolt lock device 1 comprising the bolt guide 4 and the bolt intake 5 is fixed approximately in the centre of the door wings 102, 102a. FIG. 1b shows a corresponding side view of the container door 100 and the formation of the operating opening 104 in the doorframe 101. FIG. 1c shows an aerial view of the two-winged door 100 according to FIGS. 1a and 1b partially opened outwards, having the door leaves 102 and 102a. FIG. 1d shows an aerial view of the two-winged door 100 according to FIGS. 1a and 1b partially opened outwards having the door leaves 102 and 102a, wherein inserts 105 or 105a, for example made of hard metal, are additionally installed between the guide 4 and the door leaf 102 or the intake 5 and the door leaf 102a.

FIG. 2 depicts an embodiment of essential components of the bolt lock device 1 according to the invention. FIG. 2a shows the sliding bolt 2 partially installed in the guide 4 and an assigned hard metal insert 105 that is installed between the guide 4 and a door leaf in a perspectival depiction. FIG. 2b shows an exploded depiction of the individual components of the device according to FIG. 2a. FIG. 2c shows a cross-section through the bolt 2 having the component formed on its two ends, the end piece 23 on the one hand and the padlock 31 and the assigned feed 34. FIG. 2d shows a cross-section through the bolt 2 formed as a hollow bolt having the component formed on its two ends, the end piece 23 on the one hand and the padlock 31 and the assigned feed 34, and an insert 25, for example made of hard metal, installed in the locking region of the bolt housing 24.

FIG. 3 depicts the different components of the bolt lock device 1 according to the invention working together, in particular for a two-winged door in the opened state (bolt position “A”) in a compressed depiction. FIG. 3a here shows the bolt guide 4 and the bolt intake 5 in a side view. The bolt 2 is completely enclosed by the bolt guide 4. The key 6 is laterally introduced via the operating opening 44 of the guide 4 to operate the arresting device. FIG. 3b shows a cut through the device according to FIG. 3a along the cutline D-D. FIG. 3c shows an enlargement of the portion H from FIG. 3b. FIG. 3d shows an enlarged portion G from FIG. 3d.

The padlock 31 that can be operated via the open end 44 of the guide 4 is here in particular depicted.

FIG. 4 depicts the different components of the bolt lock device 1 according to the invention working together in a compressed view, in particular for a two-winged door in the closed state (bolt position “B”). FIG. 4a here shows a side view of the bolt lock device according to the invention in the locked position. The bolt 2 can here be seen in the crack formed between the bolt guide 4 and the bolt intake 5. FIG. 4b here shows a cut depiction of the bolt lock device 1 according to the invention according to FIG. 4a along the cutline C-C. FIG. 4c shows a schematic depiction of a key 6 for operating the bolt lock device according to the invention.

FIG. 5 shows a detailed depiction of a padlock 31 used according to the invention. FIG. 5a shows a view of the keyhole and FIG. 5b shows a view of the locking pin.

FIG. 6 schematically shows a freight container 200 equipped with a two-winged door 100 and an operating opening 104 formed laterally in the doorframe 101 for the internal bolt guide 4 or bolt intake 5 according to the invention, each formed as a square tube, installed on the inner side on the door leaves 102 and 102a in a perspectival view.

### DETAILED DESCRIPTION OF THE INVENTION

### A. General Definitions

In the context of the present invention, the terms “longitudinal” and “axial” are here used synonymously, and describe a direction indication relating to an axis of a subject matter, in particular its longitudinal axis. A sliding bolt according to the invention described in more detail in the following is thus slid along its longitudinal axis, i.e., longitudinally or axially, for example. The sliding occurs in a tubular bolt guide, and thus longitudinally or axially to the longitudinal direction of the bolt guide.

### B. Preferred Embodiments

The invention relates in particular to the following preferred subject matter and embodiments:
1. A first subject matter of the invention is a bolt lock device for shutting or locking one-winged or multi-winged, in particular two-winged doors, in particular doors of transport containers, preferably metal transport containers, wherein the bolt lock device is installed on the door inner side in such a way that the device, and in particular its sliding bolt and the bolt arrest of the sliding bolt, are covered by the closed door, and a violent opening is thus prevented as far as possible.

In contrast to conventional external bolt lock devices having an external bolt arrest, the device according to the invention is additionally protected from violent opening due to its internal bolt arrest installed on its sliding bolt and connected to the sliding bolt.

The bolt lock device 1 according to the invention thus comprises an arrestable sliding bolt 2 having a first and a second bolt end 21, 22 and a corresponding tubular bolt guide 4, and is characterised in that the sliding bolt 2 of the bolt lock device 1 comprises an arresting device 3 fixed , e.g., screwed, on the first bolt end 21 facing a lateral operating opening 104, wherein the sliding bolt 2 and the arresting device 3 are arranged within a tubular bolt guide 4 and are formed in a manner able to be operated in a shiftable manner in sync, i.e. together longitudinally (i.e., axially); the sliding bolt 2 can in particular be arrested by means of the arresting device 3 in at least one pre-determined position via the bolt guide 4, wherein at least the arresting device 3 is completely or substantially completely encompassed by the bolt guide 4 in every sliding bolt position. The internal bolt arrest 3 is additionally spaced apart from the ends of the bolt guide 4 in every position of the sliding bolt, i.e., offset longitudinally (i.e., axially) inwards in the bolt guide. The arresting device 3 is thus substantially covered both in the open and in the closed state of the bolt lock device 1 by the bolt guide 4 and, as explained in the following, is only operated via a lateral opening of the bolt guide 4.

The sliding bolt 2 here has in particular an axial length that is dimensioned such that an opening of the door to be closed is enabled without removing the sliding bolt 2 from the bolt lock device 1.

An optimal length of the sliding bolt 2 can be easily determined. The length of the sliding bolt 2 can in particular be determined in a region that corresponds to less than 100% of the horizontal breadth of the door leaf inner side on which the bolt guide 4 is installed. A typical length of the sliding bolt 2 here lies in a region of 98-40%, preferably 95-50%, in particular 90-60% of the horizontal door leaf inner side. The longer the sliding bolt 2 is here formed, the higher the security of the closed door thus achieved. This applies in particular for two-winged doors, because these can engage further in the bolt intake 5 (see below) formed on the second door inner side in the closed state when a bolt length increases.

The individual components of the device according to the invention, specifically the sliding bolt 2 and bolt guide 4, but also the bolt intake 5 described below, are preferably in particular made of metal or metal alloys, in particular made of steel. All the metals or metal alloys familiar to the person skilled in the art, usually used in locking technology, can for example be used. Suitable steel qualities are typically, for example, SS235JR, S355JR, C45 or 1.4301. Further steel specifications are known, for example, from Ullmann, 4^{th} Ed., vol. 22, p. 1 163; in particular suitable high-strength and/or chemically stable steels are described in section 8 there.

Sliding bolt 2, bolt guide 4 and/or bolt intake 5 can also consist partially or entirely of “hard metal” or additionally be equipped with hard metal components at critical points. Hard metals are here understood as sintered carbide materials. Very high hardness, wear resistance and high red hardness are characteristic for hard metals. They mostly consist of a high proportion of hard metal carbides with high melting points, e.g., tungsten carbide (strengthening phase) and a low proportion of a binding metal with a low melting point, e.g., cobalt (matrix, binding means, durability components). Further suitable hard metals are described in Ullmann, 4th Ed., vol. 12, pp. 515-520, for example.

The bolt guide 4 can here be formed either as a square pipe or round pipe, and in particular as one piece. Typical wall strengths here lie in the region of approximately 3 to 20 mm, in particular 4 to 10 mm. The sliding bolt 2 is preferably made of the same material as the bolt guide 4, and has an outer cross-section that roughly corresponds to the internal cross-section of the bolt guide 4, such that an uninterrupted sliding of the bolt 2 in the bolt guide 4 is enabled. The sliding bolt 2 can also be formed as a square or round pipe. The thickness of the sliding bolt 2 can be dimensioned such that, circumferentially, a play of, for example, 1 to 5 mm in relation to the interior 46 of the housing 41 occurs. The total length of the bolt guide 4 here preferably exceeds the total length of the bolt 2, including the arresting device 3 attached to it and the optionally formed end piece 23.

In a further particular embodiment of the sliding bolt 2, said sliding bolt can have additional means for further securing the bolt lock device 1, which for example prevent or make more difficult a mechanical separation. An insert 25 making the separation more difficult can be provided within the sliding bolt 2 in the event of the embodiment as a square or round pipe. This insert 25 can for example be an internal plate made from high-strength steel or in particular hard metal (see also the above specifications and references) connected to the sliding bolt housing. The insert 25 can alternatively be constructed from a multi-layered construction of metal or in particular hard metal plates and rubber inserts. The rubber insert should be provided such that if a mechanical separation is attempted, e.g., by means of a separating disc, then the rubber insert slightly melts or runs, and adheres to the separating disc. The sliding bolt can alternatively be internally cast with an insert 25 made of concrete, and optionally inlaid steel or hard metal plates. The insert 25 can here extend either over the entire length of the bolt housing 24 or only over critical portions of the bolt housing 24 that are in particular danger. A securing of the bolt in the so-called locking region is particularly critical. Said locking region comprises the portion of the sliding bolt 2 that is enclosed neither by the bolt guide 4 nor by the bolt intake 5 in the closed state, and is thus unprotected. If the sliding bolt 2 is embodied as a massive metal rod, a recess can be provided in the closing region on the surface of the sliding bolt 2, in which a corresponding insert 25 made of hard metal is installed and fixed, e.g., screwed. The “locking region” thus corresponds to an end portion of the bolt 2 opposite the padlock 31 that in particular comprises the partial portion of the bolt that is enclosed neither by the bolt guide 4 nor the bolt intake 5 in the locked state of the device 1.

The arresting device 3 used according to the invention can be formed in any way to accomplish an arresting or de-arresting of the sliding bolt 2. It can here be operated mechanically or non-mechanically, e.g., electrically. A mechanical operation usually occurs via an operating means formed as a key, wherein the device 3 comprises a padlock that can be mechanically operated as described herein. In a non-mechanical, in particular an electrical operation, the arresting occurs by means of a padlock that for example arrests or de-arrests the sliding bolt after a corresponding electrical impulse is received. An embodiment of the arresting device 3 that allows its mechanical operation is preferred.

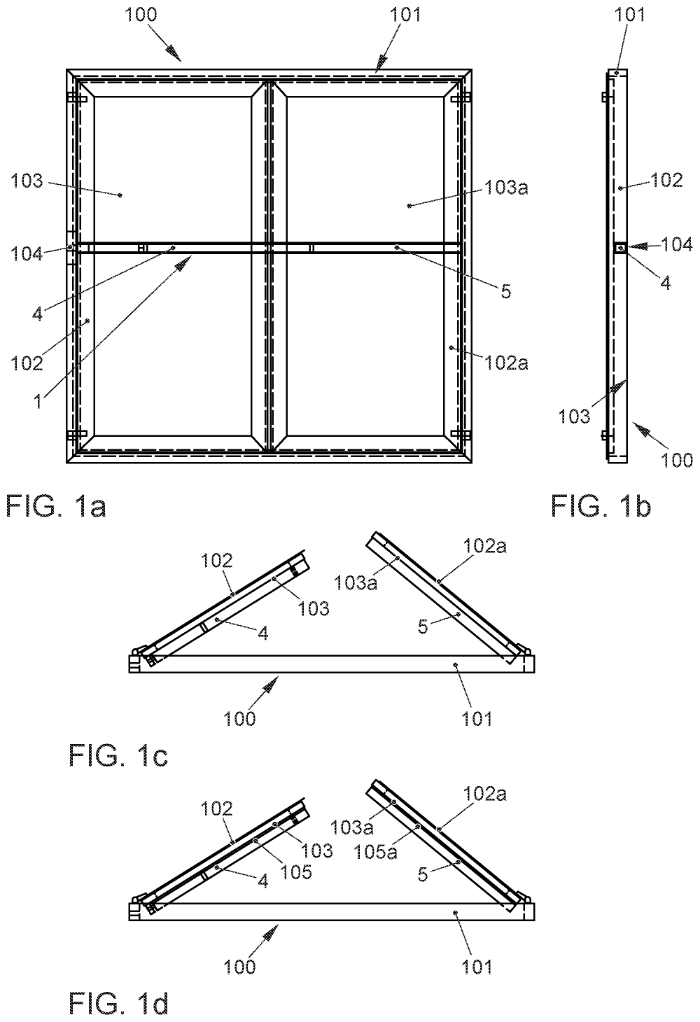

One or several bolt lock devices 1 according to the invention are usually installed on the door inner side of at least one door leaf of the transport container to be closed. The bolt lock device 1 is in particular substantially horizontally aligned, i.e., the axial operation of the sliding bolt 2 also substantially occurs horizontally. The device according to the invention can additionally be arranged at any vertical door height. Several bolt lock devices can here be distributed over the door height and be installed at different heights respectively. If only one bolt lock device is provided, then this is preferably installed approximately in the centre, i.e., approximately at half the height of the door (see also the accompanying FIG. 1a).
2. In a particular embodiment of the device according to embodiment 1, the arresting device 3 formed on the first bolt end 21 of the sliding bolt 2, and connected to the bolt 2, is arranged inwardly set back in the longitudinal (i.e., axial) direction in every bolt position of the bolt guide 4, i.e., in particular spaced apart from the operating opening 44 of the bolt guide 4.
3. In a further embodiment of the device according to embodiment 1 or 2, the sliding bolt 2 can be arrested in at least two pre-determined bolt positions A, B longitudinally (i.e., axially) offset to one each other within the bolt guide 4 by means of the arresting device 3.

The bolt position “A” here defines the open state of the bolt lock device 1, and the bolt position “B” the closed state of the bolt lock device 1.
4. In a particular embodiment of the device according to embodiment 3, the bolt guide 4 comprises a housing 41 having a first lateral opening 44 for operating the arresting device 3 (i.e., for arresting and de-arresting the sliding bolt) and/or for operating the sliding bolt 2 (i.e. for sliding the sliding bolt between the positions “A” and “B”), and a second lateral opening 45 for the exit of the second bolt end 22 of the sliding bolt 2.

The bolt position “A” is here selected such that the sliding bolt 2 is positioned so far into the housing 41 of the guide 4 that the bolt end 22 does not engage in one of the bolt intakes 5 assigned to the bolt lock device 1. The bolt 2 is here preferably pulled back into the housing 41 over its entire length.

The bolt position “B” is further selected such that the sliding bolt 2 protrudes so far out of the bolt exit opening 45 of the housing 41 of the guide 4 that the bolt end 22 engages in the bolt intake 5 assigned to the bolt lock device 1.

The tubular housing 41 thus in particular has a first opening 44 on one end that serves as an operating opening for the arresting device 3 and/or the sliding bolt 2, and is thus accessible from outside for a corresponding operating means for the internal arresting device 3, e.g., a key suitable for a locking and operating means for the arresting device 3 and the sliding bolt 2, or for a means suitable for operating i.e., sliding or pulling the sliding bolt 2. The opening 44 in particular serves to operate the arresting device 3 and the sliding bolt 2.

On the end opposite the first opening 44, the housing 41 further has a second opening 45 that serves as a bolt exit opening, from which the bolt end 22 of the sliding bolt 2 exits and engages in a bolt intake 5 provided for this purpose if the arresting device 1 locks the door.
5. In a particular embodiment of the device according to embodiment 3, the arresting device 3 is arranged offset in the longitudinal (i.e., axial) direction relative to the first opening 44 in the interior 46 of the housing 41 in every bolt position A, B.
6. In a further embodiment of the device according to one of the preceding embodiments, the arresting device 3 is releasably fixed, e.g., screwed, on the first bolt end 21 of the bolt 2, and formed flush with the bolt cross-section; the arresting device 3 can alternatively also be able to be operated enclosed by the bolt 2, i.e., in the case of an embodiment of the bolt as a round pipe or square pipe, the arresting device 3 can also be installed in the first bolt end 21 and fixed, e.g., screwed there.
7. In a further embodiment of the device according to one of the preceding embodiments, the bolt guide 4 encloses the bolt 2 and the arresting device 3 over its entire length, i.e., longitudinally (i.e., axially) substantially completely if the bolt lock device 1 is open, i.e., unlocked (bolt position A); and the bolt guide 4 encloses the arresting device 3 and the bolt 2 longitudinally (i.e., axially) only partially if the bolt lock device 1 is closed, i.e., locked (bolt position B), wherein the second bolt end 22 spaced apart from the arresting device 3 protrudes from the bolt guide 4. “Substantially” here means that recesses, e.g., slit-shaped or circular, can be formed in the bolt guide 4 on at least one of its longitudinal sides, said recesses having a sufficient size for the arresting device 3 to be able to engage to fix a bolt position pre-determined by the recess via arresting pins, but otherwise encloses the bolt 2 and arrest 3.

The bolt guide 4 or the housing 41 here in particular has an axial length that can substantially correspond to the length of the sliding bolt 2.

In another embodiment, the length of the bolt guide 4 or the housing 41 can be determined in a region that corresponds to less than 100% of the breadth of the door leaf inner side on which the bolt guide 4 is installed. A typical axial length of the bolt guide 4 or its housing 41 here lies in a region of 99%-50%, preferably 95-70%, in particular 90-85% of the breadth of the door leaf inner side.
8. In a further embodiment of the device according to one of the preceding embodiments, the arresting device 3 comprises a mechanically or non-mechanically, e.g., electrically operated padlock 31, wherein the mechanical padlock in particular can be operated via the first lateral opening 44 of the housing 41. A mechanically operated padlock is a preferred embodiment.
9. In a particular embodiment of the device according to embodiment 8, the padlock 31 can be mechanically operated via a key 6 that can be introduced longitudinally (i.e., axially) into the inside of the housing 41 via the lateral opening 44, and engages in the keyhole 33 of the padlock 31. The key is here additionally the operating means for the sliding bolt 2, i.e., the key is formed at such a length as to be sufficient to slide the sliding bolt 2 at least between the bolt positions “A” and “B” from outside via the opening 44.
10. In a particular embodiment of the device according to embodiment 9, the padlock 31 comprises at least one locking pin 32 that arrests (locks) or releases (unlocks) the bolt 2 in one of the at least two defined bolt positions A, B within the bolt guide 4 via operation of the key 6. The locking pins 32 are here operated substantially vertically to the longitudinal axis of the sliding bolt 2 or the guide 4.
11. In a particular embodiment of the device according to embodiment 10, recesses 42, 43 are formed in the housing 41 of the bolt guide 4 for each of the at least two defined bolt positions A, B, in which the locking pin 32 engages substantially vertically to the longitudinal axis of the sliding bolt 2 or the guide 4 to arrest the bolt 2, and thus arrests (locks) the bolt 2 in the respectively desired position A, B.
12. In a particular embodiment of the device according to one of embodiments 9 to 11, the key 6 is releasably connected to the arresting device 3 after the padlock 31 of the arresting device 3 is opened (unlocked). It is further formed such that it enables a longitudinal (i.e., axial) operation of the sliding bolt 2, in particular a sliding or pulling of the bolt along the longitudinal axis of the bolt guide 4. For this purpose, the key 6 can be turned into an operating position that enables the longitudinal (i.e., axial) operation of the bolt 2 after it is introduced into the keyhole 33 of the padlock 31. For this purpose, the key rod 63 of the key 6 is provided with sufficient length that it protrudes over the lateral edge of the door to be closed or its doorframe in every sliding bolt position A, B via the operating opening 44 of the guide 4. The key further preferably comprises a key bit 61 that releasably fixes the key 6 in the padlock 31 in an operating position of the former after the key is introduced into the keyhole 33, such that a sliding or pulling of the de-arrested sliding bolt 2 is enabled.
13. In a particular embodiment of the device according to one of the preceding embodiments 8 to 12, the padlock 31 comprises a feed 34 for centring the operating means for the arresting device 3 and/or the sliding bolt 2, as in particular for the key 6, on its lateral surface facing the opening 44.
14. In a particular embodiment of the device according to embodiment 13, the feed 34 is formed such that it supports the introduction of the key bit 61 of the key 6 into the keyhole 33 of the padlock 31 of the arresting device 3 set back in the guide 4.

The feed 34 above can here be made of different materials, e.g., different metals or hard plastics. Here it has, e.g., in the extension of the keyhole 33, a broadening 341 pointing outwards that can be conical or funnel-shaped, for example.
15. A further subject matter of the invention relates to a one-winged door 100 having a doorframe 101, a door leaf 102 having at least one, e.g., one, two or three, in particular one bolt lock device 1 according to one of the preceding embodiments arranged on the door inner side 103 of the door leaf 102, in particular releasably or non-releasably fixed to the door leaf 102. A first lateral operating opening 104 corresponding to the operating opening 44 of the housing 41 of the bolt guide 4 is here formed in the doorframe 101 for each bolt lock device 1, which enables the key 6 to be fed in the closed (i.e., both locked and unlocked) state of the door. A second opening 104a opposite the opening 104 in the doorframe 101 that functions as an intake 5 for the second bolt end 22 of the bolt 2 in position B of the device 1 is further formed for each bolt lock device 1.
16. A further subject matter of the invention relates to a double wing door 100 having a doorframe 101, a first door leaf 102 and a second door leaf 102a having at least one, e.g., one, two or three, in particular one bolt lock device 1 according to one of the embodiments 1 to 14 arranged on the door inner side 103 of the first door leaf 102, in particular fixed releasably or non-releasably to the door leaf 102. A first opening 104 corresponding to the operating opening 44 of the housing 41 of the bolt guide 4 is here formed in the doorframe 101 for each bolt lock device 1, which enables the key 6 to be fed in the closed (i.e., both locked and unlocked) state of the door. For each bolt lock device 1, an intake 5 is further formed on the inner side 103a of the second door leaf 102a, in particular releasably or non-releasably fixed to the door leaf 102a, for the second bolt end 22 of the bolt 2 in position B of the device 1, wherein the intake 5 is installed on the door leaf 102a such that it forms a second housing 51 that corresponds to (aligns with) the housing 41 enclosing the bolt 2, i.e., forms an extension of the housing 41 on the side of its second opening 45.

In an embodiment, the length of the bolt intake 5 or the housing 51 can be determined in a region that corresponds to less than 100% of the breadth of the door leaf inner side on which the bolt intake 5 is installed. A typical axial length of the bolt intake 5 or its housing 51 here lies in a region of 99-50%, preferably 95-90%, in particular 90-85% of the breadth of the door leaf inner side.
17. A further subject matter of the invention relates to a transport container 200 comprising at least one one-winged or two-winged door 100 according to embodiment 15 or 16, the door inner side 103, 103a of which points towards the interior of the container, wherein the inner side 103 of the first door leaf 102 carries at least one bolt lock device 1 according to one of the embodiments 1 to 14; and an intake 5 is formed for the bolt 2 of the at least one bolt lock device 1 as described in embodiment 15 or 16.

An insert 105 or 105a made of a strip of hard metal (see also information on material composition given above) of sufficient length, for example having a length identical to the bolt guide 4 or the bolt intake 5, can be provided between the bolt guide 4 and the assigned door inner side 103, or between the bolt intake 5 and the assigned door inner side 103a for further protection from violent opening of the one-winged or two-winged door provided with a bolt lock device 1 according to the invention.
18. Advantageous embodiments of transport containers according to embodiment 17 are selected from shipping freight, road freight or air freight containers, commercial vehicle trailers (trailers), e.g., semitrailers, box semitrailers and refrigerated semitrailers, such as in particular so-called standardised large capacity containers described as “ISO containers”, e.g., used as sea freight containers, in particular made of steel, that enable an easy and quick loading, transport, storage and unloading of goods.

### C. Further Embodiments of the Invention

Further embodiments of the technical teaching according to the invention are now described in more detail, taking into consideration the accompanying figures, but without limiting the invention to these concrete embodiments.

As mentioned, bolt lock devices according to the invention are used for securing internal locking of doors of fixed-walled metal transport containers, such as, for example, transport containers such as, without being limited to, shipping freight, road freight or air freight containers, commercial vehicle trailers (trailers), such as, for example semitrailers, box semitrailers and refrigerated semitrailers that have at least one one-winged or two-winged door for loading or unloading transport goods, and which should be formed in a lockable manner for secure transport.

In the accompanying FIG. 1, a two-winged container door 100 having a doorframe 101 and the two door leaves 102 and 102a is depicted in an internal view (FIG. 1a). The bolt lock device 1 here comprises the bolt guide 4 and the bolt intake 5, which are fixed horizontally on the inner side 103 or 103a of the door leaves 102 or 102a at the same height. The length of the elements 4 and 5 here corresponds approximately to the respective door leaf breadth, wherein the two elements 4 and 5 do not touch in the centre in the closed state of the doors in order to guarantee an unimpeded opening of the door halves. FIG. 1c shows an aerial view of the partially open two-winged door 100 having the door leaves 102 and 102a. FIG. 1a and 1b additionally show the formation of the approximately square lateral operating opening 104 in the frame 101 at the height of the bolt guide 4. This opening 104 is formed at such a size that the introduction of an operating means, and its further handling for operating (sliding or pulling, locking or unlocking) the sliding bolt 2 of the bolt lock device 1 (not shown in this depiction) is guaranteed. As FIG. 1c also shows, the guide 4 fixed to the door wing 102 completely covers the internal siding bolt 2 (not depicted in this figure) in the open state of the door. FIG. 1d shows an aerial view of the two-winged door 100 according to FIG. 1a and 1b having the door leaves 102 and 102a partially opened outwards, wherein hard metal inserts (see also information on material composition given above) 105 or 105a are additionally installed between the guide 4 and the door leaf 102 or the intake 5 and the door leaf 102a. These optional hard metal elements further make a violent opening of the door by splitting the bolt lock device according to the invention from outside even more difficult.

In a variant form not further depicted, a transport container could also be equipped with a one-winged door 100. The bolt lock device 1 according to the invention here substantially comprises the bolt guide 4 and the bolt 2 including its arresting device 3. The bolt intake 5 required for locking the door would however then be formed in the doorframe 101 in the extension of the bolt guide 4, for example.

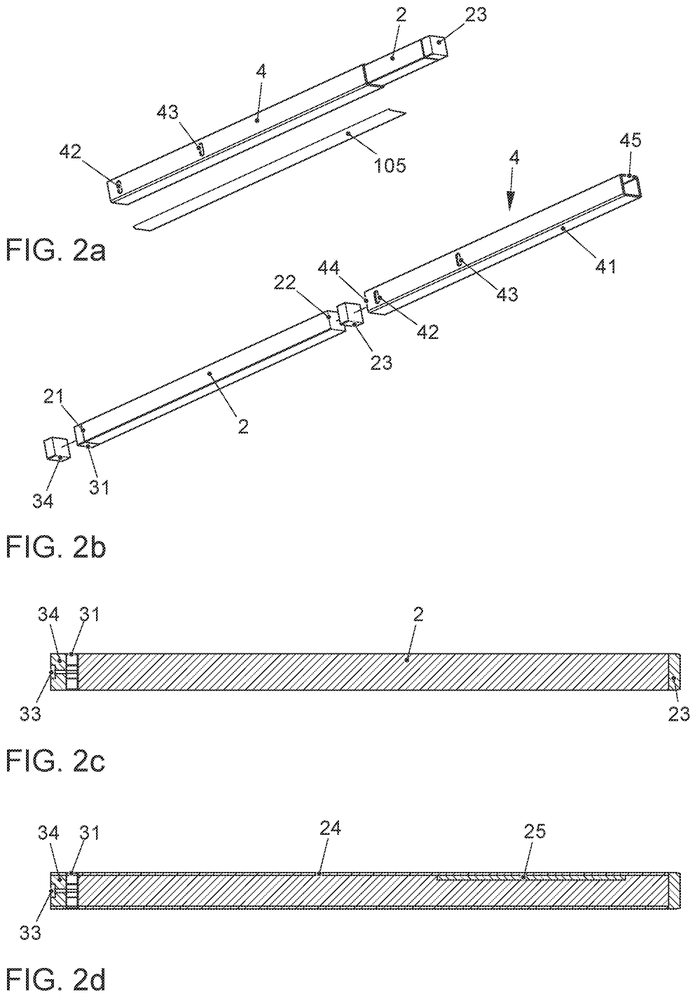

In FIG. 2, only the part of the bolt lock device according to the invention is shown that further depicts the arrestable bolt 2. FIG. 2 in particular depicts a preferred embodiment of essential components according to the invention of the bolt lock device 1 according to the invention.

FIG. 2a shows the sliding bolt 2 partially installed in the guide 4 and the recesses 42 and 43 formed laterally on the guide 4 for arresting the bolt 2 in a perspectival depiction. The guide 4 is here in particular fixed on an inner side of a door leaf of the previously shut door such that the openings 42 and 43 substantially point horizontally into the interior of the space to be shut. The guide 4 is in particular made of a square pipe that is fixedly connected to the door inner side, e.g., welded or screwed. The bolt 2 itself can here be made either from a massive square metal bolt or from a square pipe. In the latter case, an end piece 23 closing off the bolt 2 tapering outwards, e.g., made of plastic, is provided that makes a sliding of the bolt 2 in the bolt intake 5 (not shown here) easier. A hard metal insert (see also information on material composition given above) 105, assigned to the bolt guide 4 , having substantially the same length as the guide 4 is further shown, which is installed when a bolt lock device 1 according to the invention is mounted between the guide 4 and the door leaf. The insert 105 can, for example, be screwed or fixedly connected to the door leaf, or welded, as in the example for this purpose.

FIG. 2b shows an exploded depiction of the individual components of the device according to FIG. 2a. The sliding bolt 2 having the padlock 31 already fixed on its first end 21 and the feed 34 for the padlock 31, as well as the end piece 23 on the opposite second end 22 of the bolt 2 is in particular shown. Further shown is the bolt guide 4 having its two open ends 44 and 45 and the recesses 42, 43 formed in the housing 41 of the guide 4 for the locking pin (not shown here) of the padlock 31 for arresting the sliding bolt 2 in the two positions pre-determined by the two recesses 42 and 43 for the open or closed state of the device respectively. The guide 4, end piece 23, padlock 31 and feed 34 have a substantially identical cross-section. The guide 4, end piece 23, padlock 31 and feed 34 can here be connected to one another by means of suitable fixing means in a form fit manner or in another suitable manner, e.g., via adherence, in the order shown in FIG. 2b.

FIG. 2c shows a longitudinal cut through the hollow bolt 2, formed by a square pipe, along its longitudinal axis having the end piece 23 installed on its two ends having slanted outer edges on the one hand and the padlock 31, and the assigned feed 34 and the extension 341 of the keyhole 33 formed in the feed 34 broadening outwards. The feed 34, padlock 31 and end piece 23 have a substantially identical cross-section to the sliding bolt 2.

FIG. 2d shows a cross-section through a bolt 2 formed as a hollow bolt, for example formed from a square pipe, having the components formed on its two ends, the end piece 23 on the one hand and the padlock 31, and the assigned feed 34, and a hard metal insert (see also information on material composition given above) 25 installed in the locking region of the bolt housing 24. This insert 25 arranged on the inner side of the housing 24 can for example be screwed to the housing 24 from outside.

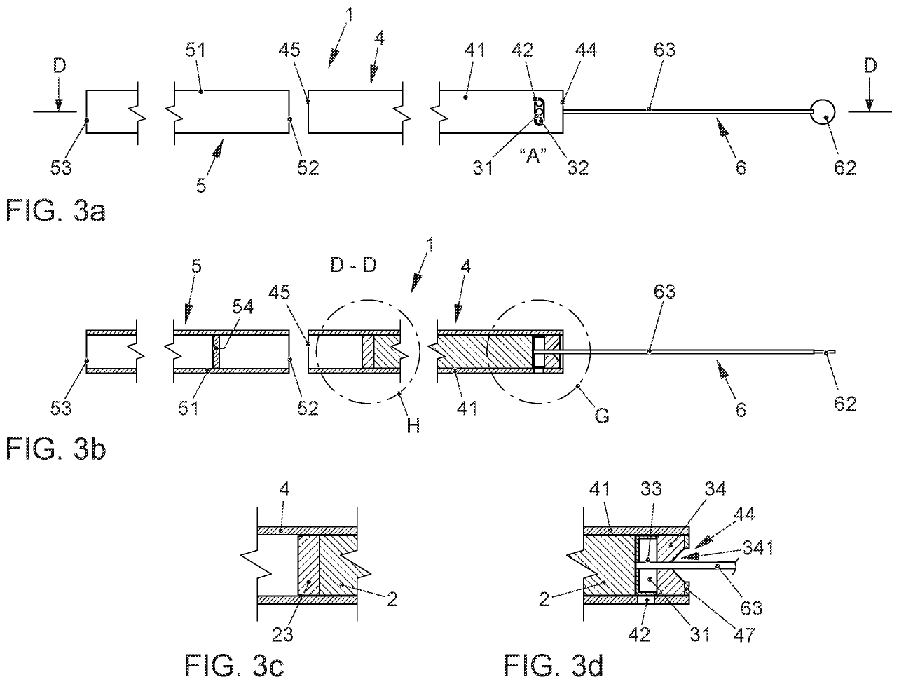

In FIG. 3, the manner in which the different components of the bolt lock device 1 according to the invention work together in the open state (bolt position “A”) is shown in a compressed depiction. FIG. 3a here shows the bolt guide 4 and the bolt intake 5 in a side view. The bolt 2 is enclosed around its entire circumference by the bolt guide 4. The two bolt ends 21 and 22 (not shown here), but in particular also the padlock 31 installed on the bolt end 21, are completely covered by the housing 41. The padlock 31 can thus only be operated from outside via a corresponding operating means, here the key 6, that serves to slide the bolt 2 in the guide 4 in the open position of the bolt lock 31. The recess 42 is formed in the housing 41 such that the locking pin 32 of the padlock 31 can engage vertically to the operating direction of the sliding bolt 2 to fix the arresting device 3 in position “A” corresponding to the open state of the bolt locking device. The key 6 is introduced laterally via the operating opening 44 of the guide 4 to operate the arresting device. The bolt intake 5 having the two ends 52 and 53 of the housing 51 is further shown. The end 52 of the housing 51 is spaced apart from the end 45 of the housing 41 of the bolt guide 4, and thus the sliding bolt 2 does not engage in the bolt intake 5 when arrested in position “A”. FIG. 3b shows a longitudinal cut through the device according to FIG. 3a along the cutline D-D. A stop 54 for the sliding bolt 2 formed in the housing 51 of the bolt intake 5 is here additionally depicted, said stop pre-determining the bolt position “B”, for example. FIG. 3c shows an enlargement of the portion H from FIG. 3b. FIG. 3d shows an enlargement of the portion G from FIG. 3b. FIG. 3b shows the two elements 4 and 5 formed from square pipes with identical cross-sections, i.e., the bolt guide and bolt intake. In the portion according to FIG. 3c, the end piece 23 having slanted outer edges installed on the sliding bolt 2 on its end spaced apart from the padlock 31 is depicted, said end stop being set back inwards in the bolt guide 4 in the position of the bolt 2 shown. The padlock 31 is additionally set back in the interior of the housing 41 in the same bolt position. The guide 34 finishes approximately flush with the opening 44 of the housing 41. A stop can here optionally be provided on the housing end in order to avoid a complete extraction of the bolt 2 from the housing 41. The padlock 31 that can be operated via the open end 44 of the housing 41 of the guide 4 is additionally in particular depicted in FIG. 3d. The feed 34 has a funnel-shaped opening 341 broadening outwards in the extension of the keyhole 33 that makes it easier for the key 6 to be fed to the padlock 31 from outside. A stop 47 for the sliding bolt 2 is additionally formed at the operating opening 44 that, for example, pre-determines the lock position “A”.

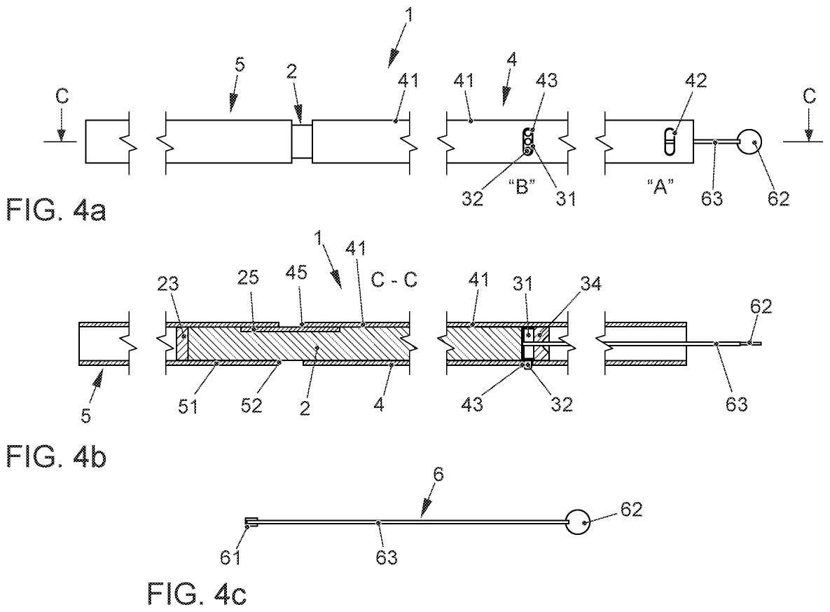

FIG. 4 shows the manner in which the different components of the bolt lock device 1 according to the invention work together in the closed state (bolt position “B”) in a compressed depiction. The FIGS. 4a and 4b otherwise correspond to the FIGS. 3a and 3b. FIG. 4a here shows the bolt lock device according to the invention in the locked position. The locking region of the bolt 2 can here be seen in the crack, formed between the bolt guide 4 and the bolt intake 5, between the end 52 of the bolt intake 5 and the end 45 of the housing 41 of the bolt guide 4. In the second lateral opening 43 of the guide housing 41, the locked pins 32 of the padlock 31 covered by the housing can be seen. FIG. 4b shows a cut depiction of the bolt lock device 1 according to the invention according to FIG. 4a along the cutline C-C. FIG. 4c shows a schematic depiction of a key 6, comprising a key bit 61, a key ring 62 and a key rod 63 for operating the bolt lock device 1 according to the invention, i.e., for arresting and de-arresting the lock 31 and for sliding the sliding bolt 2. The key rod 63 is here formed at a sufficient length to guarantee the operation of the sliding bolt 2 from outside via the operating opening 44, in particular a sliding between the positions “A” and “B”, corresponding to the recesses 42 and 43 in the housing 41 of the bolt guide 4.

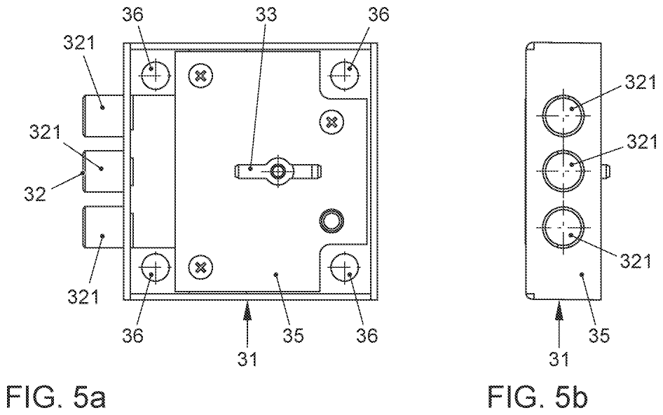

FIG. 5 shows a detailed depiction of a bolt lock 31 used according to the invention, having an approximately square cross-section. FIG. 5a shows a view of the keyhole and FIG. 5b shows a view of the locking pin. The locking pin 32 comprising the three individual pins 321, the keyhole 33 and the lock box 35 of the padlock are here depicted in more detail. The padlock 31 can be fixed, e.g. screwed, on the second bolt end 22 of the sliding bolt 2, via the fixing points 36.

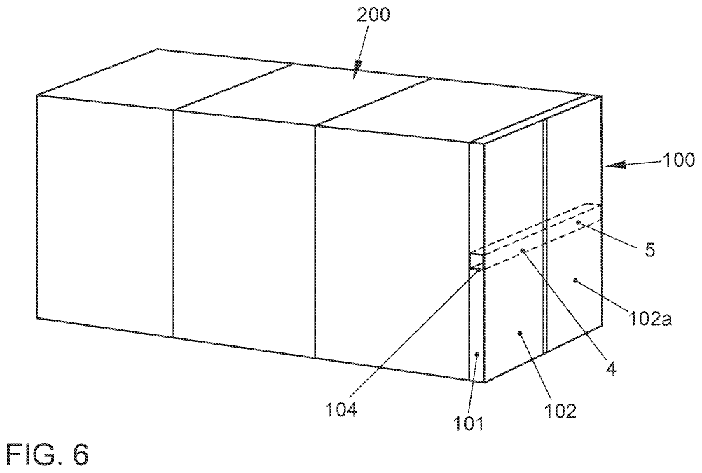

FIG. 6 shows a freight container 200 in a schematic view, provided with a two-winged door 100 and an operating opening 104 formed laterally in the doorframe 101 for the bolt lock device 1 according to the invention. This operating opening is formed on the inner side of the two door wings 102 and 102a. The two components, i.e., the bolt guide 4 of the bolt lock device 1 and the bolt intake 5 that are fixed on the respective inner surfaces of the door wings 102 or 102a are thus schematically depicted with a dashed line.

### LIST OF REFERENCE NUMERALS

1 bolt lock device
2 bolt, sliding bolt
3 arresting device for bolt
4 guide for bolt
5 intake for bolt
6 key, locking and/or operating means
21 first bolt end (facing the lateral operating opening 104)
22 second bolt end (facing the bolt intake 5 or the lateral opening 104a)
23 end piece
24 bolt housing
25 insert
31 locking cylinder/ padlock
32 locking pin/bolt
321 pin
33 keyhole
34 feed
341 broadening (extension of the keyhole)
35 lock box
36 fixing point
41 housing
42 first lateral recess (first arresting opening)
43 second lateral recess (second arresting opening)
44 first opening, operating opening
45 second opening, bolt exit opening
46 interior of the housing
47 stop for sliding bolt
51 housing
52 first opening, bolt entry opening
53 second opening
54 stop for sliding bolt
61 key bit
62 key ring
63 key rod
A first bolt position
B second bolt position
100 door (one- or two-winged)
101 doorframe
102 door leaf
102a door leaf
103 door inner side
103a door inner side
104 lateral operating opening in the frame
104a second lateral operating opening in the frame (intake for bolt)
105 insert
105a insert
200 container

1. A bolt-lock device comprising an arrestable sliding bolt having a first and a second bolt end and a corresponding bolt guide,
characterized in that
the sliding bolt (2) of the bolt lock device (1) comprises an arresting device (3) fixed on the first bolt end (21), wherein the sliding bolt (2) and the arresting device (3) are arranged within an in particular tubular bolt guide (4) such that they can be operated by being slid together, wherein at least the arresting device (3) is encompassed by the bolt guide (4) in every bolt position.

2. The bolt-lock device according to claim 1, wherein the arresting device (3) fixed on the first bolt end (21) of the sliding bolt (2) is arranged inwardly set back in the bolt guide (4) in every bolt position.

3. The bolt-lock device according to claim 1, wherein the sliding bolt (2) can be arrested in at least two pre-determined bolt positions (A, B) longitudinally offset to each other within the bolt guide (4) by means of the arresting device (3).

4. The bolt-lock device according to claim 3, wherein the bolt guide (4) comprises a housing (41) having a first lateral opening (44) for operating the arresting device (3) and/or the sliding bolt (2), and a second lateral opening (45) for the exit of the second bolt end (22) of bolt.

5. The bolt-lock device according to claim 3, wherein the arresting device (3) is arranged offset relative to the first opening (44) in the interior (46) of the housing (41) in every bolt position (A, B).

6. The bolt-lock device according to claim 1, wherein the bolt guide (4) completely longitudinally encloses the bolt (2) and the arresting device (3) over the entire length if the bolt lock device (1) is open (position A), and wherein the bolt guide (4) partially longitudinally encloses the arresting device (3) and the bolt (2) if the bolt lock device (1) is closed (position B), wherein the second bolt end (22) spaced apart from the arresting device (3) protrudes from the bolt guide (4).

7. The bolt-lock device according to claim 1, wherein the arresting device (3) comprises a padlock (31) that can in particular be operated mechanically or non-mechanically, wherein the mechanical padlock in particular can be operated via the first lateral opening (44) of the housing (41).

8. The bolt-lock device according to claim 7, wherein the padlock (31) can be operated via an operating means (6), optionally formed as a key, which can be introduced longitudinally into the inside of the housing (41) via the lateral opening (44) and engages in the corresponding opening (33) of the padlock (31), optionally formed as a keyhole.

9. The bolt-lock device according to claim 8, wherein the padlock (31) comprises at least one locking pin (32) that arrests or releases the bolt (2) in one of the at least two defined positions (A, B) within the bolt guide (4), optionally via the key (6) being operated.

10. The bolt-lock device according to claim 9, wherein recesses (42, 43) are formed in the housing (41) of the bolt guide (4) for each of the at least two defined positions (A, B), in which the locking pin (32) engages to arrest the bolt (2), and thus arrests the bolt (2) in the respectively desired position (A, B).

11. The bolt-lock device according to claim 8, wherein the operating means (6), optionally formed as a key, is releasably connected to the arresting device (3) after the padlock (31) of the arresting device (3) is opened, and enables a longitudinal operation of the sliding bolt (2) in the guide (4).

12. The bolt-lock device according to claim 7, wherein the padlock (31) comprises a feed (34) for centring the operating means (6), optionally formed as a key, on its lateral surface facing the opening (44).

13. The bolt-lock device according to claim 12, wherein the operating means (6) is a key, and the feed (34) supports the introduction of the key bit (61) into the keyhole (33) of the padlock (31) of the arresting device (3).

14. A door (100) having a doorframe (101), a first door leaf (102) having at least one bolt lock device (1) according to claim 1 one of the preceding claims arranged on the door inner side (103) of the door leaf (102), in particular fixed to the door leaf (102), wherein a first opening (104) corresponding to the operating opening (44) of the housing (41) of the bolt guide (4) is formed in the doorframe (101), which enables the key (6) to be fed in the closed state of the door; and having a second opening (104a) formed on the doorframe (101) as an intake (5) for the second bolt end (22) of the bolt (2) in position (B) of the device (1).

15. A double wing door having a doorframe (101), a first door leaf (102) and a second door leaf (102a) having at least one bolt lock device (1) according to claim 1 arranged on the door inner side (103) of the first door leaf (102), in particular fixed to the door leaf (102), wherein a first opening (104) corresponding to the operating opening (44) of the housing (41) of the bolt guide (4) is formed in the doorframe (101), which enables the key (6) to be fed in the closed state of the door; and having an intake (5) formed on the inner side (103a) of the second door leaf (102a), in particular fixed to the door leaf (102a), for the second bolt end (22) of the bolt (2) in position (B) of the device (1), wherein the intake (5) is installed on the door leaf (102a) such that it forms a second housing (51) that corresponds to the housing (41) enclosing the bolt (2).

16. A transport container (200) comprising at least one one-winged or two-winged door (100) according to claim 14, the door inner side (103, 103a) of which points towards the interior of the container, wherein the inner side (103) of the first door leaf (102) carries at least one bolt lock device (1) according to one of claims 1 to 14; and an intake (5) is formed for the bolt (2) of the at least one bolt lock device (1).

17. A bolting device according to onc of claim 1, wherein the sliding bolt 2 has an axial length that is sized such that it enables an opening of the door to be closed without removing the sliding bolt 2 from the bolt lock device 1.

18. The bolting device according to claim 17, wherein the length of the sliding bolt 2 lies in a region that corresponds to less than 100%, such as approximately 98-40%, preferably 95-50% or 90-60% of the horizontal breadth of the door leaf inner side on which the bolt guide 4 is installed.

19. The bolting device according to claim 1, wherein the axial length of the bolt guide 4 or the housing 41 lies in a region that corresponds to less than 100%, such as approximately 99%-50%, preferably 95% to 70%, in particular 90% to 85% of the horizontal breadth of the door leaf inner side on which the bolt guide 4 is installed.

20. A double wing door according to claim 15, wherein the length of the bolt intake 5 or the housing 51 lies in a region that corresponds to less than 100%, such as approximately 99-50%, preferably 95-80%, in particular 90-85% of the horizontal breadth of the door leaf inner side on which the bolt intake 5 is installed.
